(19) United States
(12) Patent Application Publication
(10) Pub. No.: US 2024/0385031 A1
(43) Pub. Date: Nov. 21, 2024

(54) SYSTEMS AND METHODS FOR DYNAMIC NOISE ANALYSIS

(71) Applicant: Urban Solution Group, Denver, CO (US)

(72) Inventors: Heidi Gill, Golden, CO (US); Lindsey Apland, Castle Rock, CO (US)

(21) Appl. No.: 18/667,232

(22) Filed: May 17, 2024

Related U.S. Application Data
(60) Provisional application No. 63/502,697, filed on May 17, 2023.

(51) Int. Cl. G01H 3/12; G06Q 30/018; G06T 11/20

(52) U.S. Cl. CPC G01H 3/125; G06Q 30/018; G06T 11/206

(57) ABSTRACT

A system for dynamic noise compliance is provided. The system includes a computer device programmed to: a) store a plurality of information about a plurality of parameters for one or more noise studies; b) store one or more models of noise emissions; c) receive updated information about a first noise study; d) execute the one or more models of noise emissions with the updated information as inputs to generate an updated model of noise emissions for the first noise study; e) generate a first map overlay for the first noise study based upon the updated model of noise emissions for the first noise study; and/or f) transmit instructions to a user computer device to cause a map with the first map overlay to be displayed on a display device of the user computer device.

### CROSS REFERENCE TO RELATED APPLICATIONS

This application claims priority to U.S. Provisional Application No. 63/502,697, filed May 17, 2023, which is hereby incorporated by reference in its entirety.

### BACKGROUND

The field of the invention relates generally to dynamic noise analysis, and more specifically to, systems and methods for dynamic acoustic modelling, monitoring, and mitigation for potential noise impacts.

There are a plurality of regulatory and planning issues that arise due to industrial development. This is especially true in the field of energy development. One major issue is noise impacts of industrial projects, both during the construction phase and well as during operation of those projects. These projects require a plurality of different noise studies including, but not limited to, Ambient Monitoring Studies, Equip Noise Signatures, Continuous Noise Monitoring Studies, Noise Impact Assessment, and/or Noise Mitigation plans. Accordingly, it would be advisable to have a system to coordinate the noise studies and allow for analyzing dynamic changes to the projects.

### BRIEF DESCRIPTION

In one aspect, a computer system for building, simulating, and/or validating a predictive model may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include a computing device that may include at least one processor in communication with at least one memory device. The at least one processor may be configured to: (1) store a plurality of information about a plurality of parameters for one or more noise studies; (2) store one or more models of noise emissions; (3) receive updated information about a first noise study; (4) execute the one or more models of noise emissions with the updated information as inputs to generate an updated model of noise emissions for the first noise study; (5) generate a first map overlay for the first noise study based upon the updated model of noise emissions for the first noise study; and/or (6) transmit instructions to a user computer device to cause a map with the first map overlay to be displayed on a display device of the user computer device. The computer system may include additional, less, or alternate functionality, including that discussed elsewhere herein.

In another aspect, a computer-implemented method for building, simulating, and/or validating a machine learning model may be provided. The computer-implemented method may be performed by a computer device including at least one processor in communication with at least one memory device. The method may include: (1) storing a plurality of information about a plurality of parameters for one or more noise studies; (2) storing one or more models of noise emissions; (3) receiving updated information about a first noise study; (4) executing the one or more models of noise emissions with the updated information as inputs to generate an updated model of noise emissions for the first noise study; (5) generating a first map overlay for the first noise study based upon the updated model of noise emissions for the first noise study; and/or (6) transmitting instructions to a user computer device to cause a map with the first map overlay to be displayed on a display device of the user computer device. The computer-implemented method may include additional, less, or alternate actions, including those discussed elsewhere herein.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) store a plurality of information about a plurality of parameters for one or more noise studies; (2) store one or more models of noise emissions; (3) receive updated information about a first noise study; (4) execute the one or more models of noise emissions with the updated information as inputs to generate an updated model of noise emissions for the first noise study; (5) generate a first map overlay for the first noise study based upon the updated model of noise emissions for the first noise study; and/or (6) transmit instructions to a user computer device to cause a map with the first map overlay to be displayed on a display device of the user computer device. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary architecture for a personal privacy preserving (PPP) system, in accordance with at least one embodiment.

FIG. 2 illustrates an exemplary computer-implemented method for dynamic noise compliance using the noise monitoring and analysis (NMA) system shown in FIG. 3.

FIG. 3 depicts a simplified block diagram of an exemplary noise monitoring and analysis (NMA) system in accordance with at least one embodiment.

FIG. 4 depicts an exemplary configuration of a user computer device shown in FIG. 3, in accordance with one embodiment of the present disclosure.

FIG. 5 depicts an exemplary configuration of a server in accordance with one embodiment of the present disclosure.

FIG. 6 illustrates an exemplary user interface for use with the NMA system shown in FIG. 3.

FIG. 7 illustrates an exemplary user interface for setting up a noise study for use with the NMA system shown in FIG. 3.

FIG. 8 illustrates the exemplary user interface being used to set-up monitor stations shown in FIG. 3 for a noise study.

FIG. 9 illustrates an exemplary user interface being used to monitor a noise study.

FIG. 10 illustrates a graph of the results of one or more monitor stations 330 shown in FIG. 3.

FIG. 11 illustrates a map of an area with sites and monitor stations for one or more noise studies.

FIG. 12 illustrates an updated map of the map shown in FIG. 11 for the one or more noise studies.

FIG. 13 illustrates a report user interface that provides information about the noise studies.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

The field of the disclosure relates generally to dynamic noise analysis, and more specifically to, systems and methods for dynamic acoustic modelling, monitoring, and mitigation for potential noise impacts. This disclosure describes a noise monitoring and analysis (NMA) system configured to assist in navigating regulatory and planning challenges surrounding numerous types of industrial development, with a focus on noise impacts. The NMA system provides proper tracking and management through the planning permitting, development, and operational stages of industrial projects.

In the exemplary embodiment, the NMA system embeds, tracks, and manages noise modeling, monitoring, and mitigation. The NMA system assists users in proactively planning for and mitigating potential noise impacts from different types of development. In some embodiments, the NMA system is used to assist users in obtaining permits, as well as conducting and proving compliant operations for development.

The NMA system assists in managing the workflow, tracking, and storing of data for a variety of different noise studies including (but not limited to) Ambient Monitoring Studies, Equipment Noise Signature, Continuous Noise Monitoring studies, Noise Impact Assessments (NIA), and Noise Mitigation Plans (NMP). In some embodiments, these studies and services may be a permitting requirement. In some further embodiments, the NMA system uses the studies to assist companies in proactive planning. The NMA system may also use the studies in compliance and grievance management during the execution phase of operations.

In the exemplary embodiment, the NMA system manages and progresses noise studies is from the time the study is created or submitted, until the time the study is completed, and the final report is stored by the NMA system. The NMA system monitors the study as it progresses. The NMA system then generates and transmits notifications and tasks to one or more user computer devices during the study progression. In some embodiments, the notifications and/or tasks prompt users to take different needed actions. The notifications and/or tasks are configured to direct users where to go in the system to complete the action needed to progress the study forward. In some embodiments, these notifications include, but are not limited to, emails, text notifications, messaging app notifications, push notifications, and/or other notification types as needed.

The NMA system tracks and manages all internal communications, and externally with customers and regulators at the noise study level by storing a communication log for each study in the system. The NMA system provides dashboards with analytics and notifications to project manage workflow and increase efficiency when managing studies in real time. The NMA system also allows customer managers to manage and track employee workload and productivity by quantifying studies including completed, in progress, and not started studies.

For each noise study, the NMA system has a file storage area to allow for users to easily share and store files within each study. This allows for easy tracking and accessing of information between all users between the companies. The NMA system securely stores the data so companies can continue to utilize institutional data and learn.

Furthermore, the NMA system includes a geographic information system (GIS) mapping feature that assists in quantifying and displaying technical data from the noise studies spatially. The NMA system allows for the ability to view live streaming noise data, along with importing open-source files, including but not limited to GeoJson and KML, to create map overlays. These map overlays include but are not limited to converting preliminary unmitigated and mitigated results from the noise studies to showcase cumulative impact reductions.

In the exemplary embodiment, the NMA system tracks and manages noise modeling, monitoring and mitigation study data. This includes uploading, downloading, and storing important noise study files including grading plans, location layouts, equipment lists, mitigation descriptions, and reports. The NMA system generates outlines and tracks key points of contact and critical communication for the customer/user. The NMA system is configured to transmit automatic email notifications for noise study progress, status updates and noise monitor alerts. The NMA system documents decisions made and logic for each noise study. The NMA system provides transparency and collaboration across internal teams for a customer/user. The NMA system provides customized reports that are easy to export. The NMA system generates and provides GIS mapping features that tie noise study data to specific location/projects. In some embodiments, the NMA system provides customer feedback options.

In the exemplary embodiment, the NMA system provides a centralized ‘Home Base’ for all past, present, future noise data. The NMA system allows users to be able to take Equipment Noise Signatures, Noise Impact Assessments, reports, and processed data and convert them to an open-source file, such as, but not limited to, GeoJson, KML, etc. This will allow the NMA system to overlay these on top of GIS layers that incorporate other data elements and utilize the data for planning purposes. In some further embodiments, the NMA system rotates shapefiles 360 degrees manually on a GIS layer.

In the exemplary embodiment, the NMA system includes a Noise Explorer feature that allows users to move and rotate visual data overlays. These overlays may be used to proactively assess locations for project siting and noise impacts for sensitive receptors. The NMA system is configured to host live Continuous Noise Monitoring sound studies with multiple users and monitors, at various locations simultaneously. The NMA system uses this data for live online viewing and includes the capability to listen to audio clips. In some embodiments, the NMA system generates these clips are generated based on alert parameters set for each monitor in the study.

For the purposes of this discussion, the noise studies may include, but are not limited to, ambient studies, noise impact assessment studies, noise mitigation plans, Equipment Noise Signature studies, and continuous monitoring studies.

Ambient Studies are sound studies from monitors deployed in an area to determine noise levels prior to operations beginning. During ambient studies, monitors are used for the study. Surface permission, monitor placement approval, and deployment date is managed in the noise module of the NMA system. All communication information is tracked within the study, and files can be shared and stored within the NMA system.

Noise Impact Assessment Studies use predictive noise models that are developed to assess potential noise impact from a planned operation and any compliance challenges. All communication information is tracked within the study, and files can be shared and stored within the NMA system.

Noise Mitigation Plans use technical noise models and mitigation plans to determine what mitigation is required to achieve compliance to achieve permit success. All communication information is tracked within the study, and files can be shared and stored within the NMA system.

Equipment Noise Signature Studies is a multi-point study that evaluates noise sources and identifies and documents a full spectrum equipment sound signature. This data is used by the NMA system to generate an “Equipment Noise Signature” that can then be used as an input to produce a site-specific Noise Impact Assessment (NIA) that predicts operational impacts to surrounding receptor/compliance points. All communication information is tracked within the study, and files can be shared and stored within the NMA system.

Continuous Monitoring Studies use robust field noise monitoring programs. Live noise and weather data streaming is accessed by the NMA system. This service ensures operational noise levels are monitored and weather conditions are tracked at each site to assist in the verification of operational compliance. Surface permission, monitor placement approval, and deployment date is all managed in the noise module.

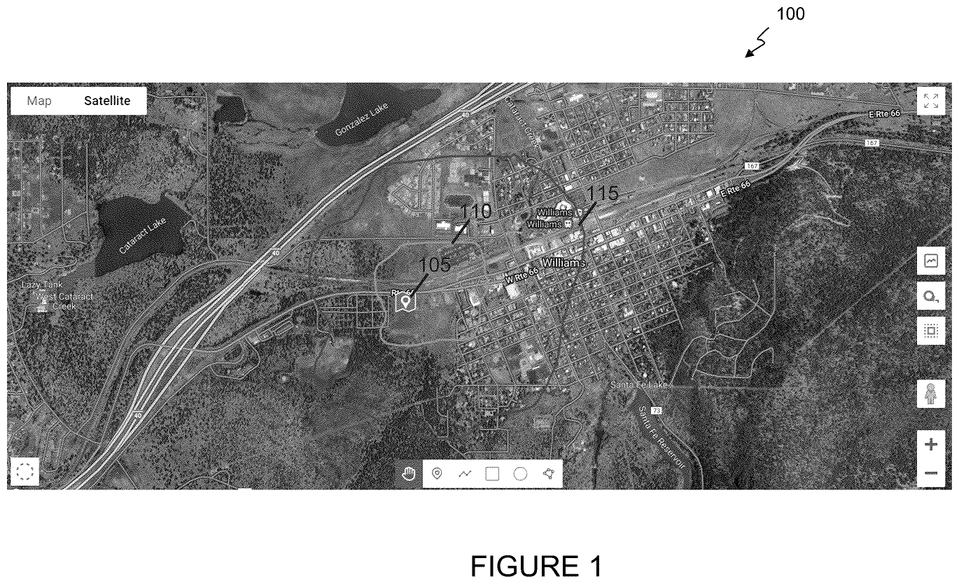

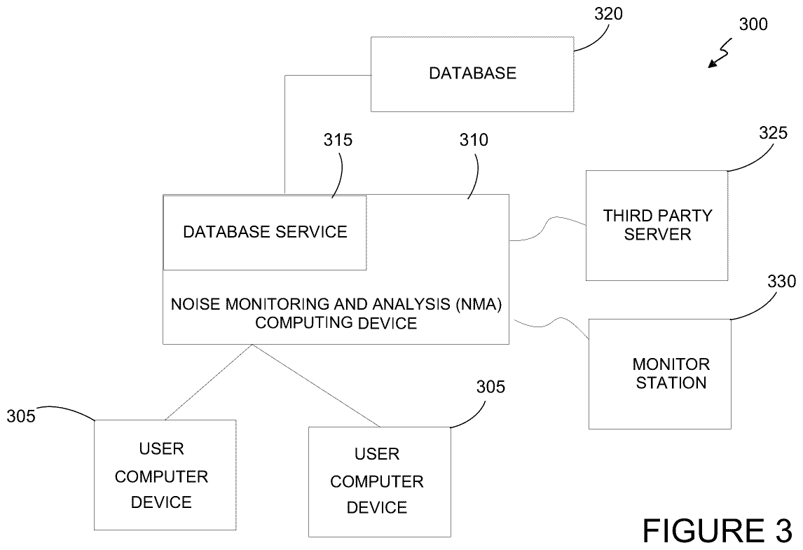

FIG. 1 illustrates an exemplary system view of the results of a noise contour map 100, in accordance with at least one embodiment of the disclosure. Noise contour map 100 shows the site 105 being analyzed, the mitigated noise contour 110 and the unmitigated noise contour 115. In the exemplary embodiment, the noise contour map 100 and its contents are generated by the NMA computer device 310 (shown in FIG. 3).

With the evolving environmental and social regulations surrounding urban or rural development, proactive planning and compliant operations are critical for any business to obtain permits and operate. This is particularly relevant with industrial operations near humans. It is critical that companies evaluate both the technical and the social considerations as they plan for future development.

NMA computer device 310 provides a platform for industrial operations that assists with both the technical and social components of a project and operation. To effectively do this, not only do users need to properly manage the internal objectives associated with these tasks, but users need to be able to showcase to regulators and communities the prudent efforts made during both planning and permitting, and operations and execution. This is accomplished through both the Noise and Stakeholder Modules provided by the NMA computer device 310.

Noise Modeling and Monitoring requirements are becoming more challenging, regulated and are undeniably critical path items for continued development. The Noise Module provides an interactive way to evaluate, track, manage and report on noise impacts and mitigations. This helps operators and developers plan, navigate, and execute compliant development and operations with reliability and speed.

The Noise Module assists customers in permitting process, and operations, by providing an innovative, comprehensive Noise Platform to manage all noise requirements under various regulations and project requirements. Each noise assessment involves generating detailed noise contour graphics, such as mitigated noise contour 110 and the unmitigated noise contour 115, which are produced by the NMA computer device 310 in the modeling software and then converted into different digital formats including, but not limited to, KML, Shapefile, and GeoJSON. These contour maps 100 are subsequently integrated as interactive layers, allowing operators to overlay these with the Stakeholder Module's mapping features as shown in FIG. 1. This integration gives a holistic view when evaluating projects, combining technical noise data with social data, thereby enabling more informed decision making and stakeholder engagement.

The Stakeholder module is configured to assist operators and developers with properly engaging the community about its operations and providing a central hub to track those engagement and grievance management efforts. The Stakeholder module then takes this human component and overlays it with operational data (Noise Module data), such as that provided by third-party servers 325 (shown in FIG. 3). The Stakeholder Module hosts a proprietary ticket triage system that assists in obtaining human data pertaining to the planning and operations of permitting and development. This also serves as a grievance management system in the system as well and can all be linked to the noise module mapping components.

Showcasing the operational data along with the human data helps paint the full picture surrounding a project and is highly valuable in planning, permitting and execution. The NMA computer device 310 allows for the spatially showcase of noise, nuisance cumulative impacts, and reductions. The NMA computer device 310 also provides human feedback to regulators, communities, and stakeholders. This aids in demonstrating operator prudency and achieving permit approvals along with showcasing ongoing operational compliance.

The NMA computer device 310 and each module provide customers a solution for multi-team collaboration to ensure proper documentation of decisions made at time of permitting and compliance through execution. This documentation can also be used to defend proper compliance with customer adhering to proper international standards for collecting and processing noise data should include details of decision and methodologies come into question in cases of defending customer noise levels and/or compliance. The operator may defend the operational considerations of the project alongside the human considerations. The NMA computer device 310 also provides a centralized tool to help assist in their planning and permitting efforts along with ensuring successful execution and compliance. The NMA computer device 310 provides centralized noise and stakeholder data storage, lessons learned and institutional operational knowledge.

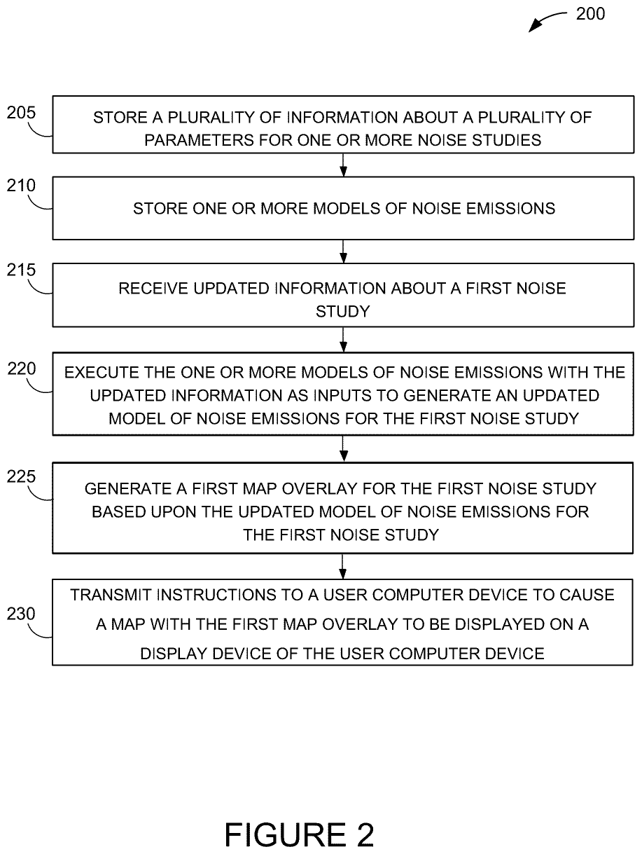

FIG. 2 illustrates an exemplary computer-implemented method 200 for dynamic noise compliance using the noise monitoring and analysis (NMA) system 300 (shown in FIG. 3). The computer-implemented method 200 may be implemented via one or more processors, transceivers, servers, sensors, applications, mobile applications, chatbots (or voice-bots), and related technologies. In some embodiments, method 200 may be carried out by the noise monitoring and analysis (NMA) server 310 (shown in FIG. 3) in communication with one or more user computer device 305.

In the exemplary embodiment, the NMA server 310 stores 205 a plurality of information about a plurality of parameters for one or more noise studies. In some embodiments, the plurality of parameters includes a plurality of compliance regulations for noise emissions and wherein the updated model of the first noise study. The NMA server 310 determines whether or not one or more sites 105 (shown in FIG. 1) associated with the first noise study are in compliance with the plurality of compliance regulations. In the exemplary embodiment, the plurality of information is stored in one or more databases 320 (shown in FIG. 3).

In the exemplary embodiment, the NMA server 310 stores 210 one or more models of noise emissions. In the exemplary embodiment, the models are stored in the one or more databases 320. In the exemplary embodiment, the NMA server 310 receives 215 updated information about a first noise study. In the exemplary embodiment, the NMA server 310 executes 220 the one or more models of noise emissions with the updated information as inputs to generate an updated model of noise emissions for the first noise study.

In the exemplary embodiment, the NMA server 310 generates 225 a first map overlay for the first noise study based upon the updated model of noise emissions for the first noise study. In the exemplary embodiment, the NMA server 310 transmits 230 instructions to a user computer device 305 to cause a map 100 (shown in FIG. 1) with the first map overlay to be displayed on a display device of the user computer device 305.

In a further embodiment, the NMA server 310 generates the first map overlay to include a first area indicating noise contours 110 (shown in FIG. 1) of mitigated compliance. The NMA server 310 also generates the first map overlay to include a second area indicating noise contours 115 (shown in FIG. 1) of unmitigated compliance.

In yet a further embodiment, the NMA server 310 transmits notifications about a current stage of the first noise study to a user computer device 305.

In yet a further embodiment, the NMA server 310 is in communication with one or more monitor stations 330 (shown in FIG. 3). The NMA server 310 is configured to receive current noise emissions from the one or more monitor stations 330.

In another embodiment, the NMA server 310 executes the updated model of the first noise study with the current noise emissions as inputs to generate the current updated model of noise emissions for the first noise study. The NMA server 310 updates the first map overlay for the first noise study based upon the current model of noise emissions for the first noise study.

In still a further embodiment, the NMA server 310 stores the plurality of information about the plurality of parameters for a plurality of noise studies including the first noise study. The NMA server 310 displays information about one or more of the plurality of noise studies.

In at least one embodiment, once a user is logged in to the NMA system 300 (shown in FIG. 3), the NMA server 310 creates a noise study based upon information submitted by a user. For example, the user selects “New” under a Study Search dashboard area. The user then selects the Study Type. For example, Study Types may include, but are not limited to, Ambient, Continuous Monitoring, Noise Impact Assessment, Equipment Noise Signature and Noise Mitigation Plan. Each study requires different information to be collected in the General tab to accurately document what is needed. The list below describes the different types of information needed, with required fields marked with an
Ambient: Site*, Customer Contact*, Urban Contact, Regulation, Report Due Date*, Monitor Deploy Date, Monitor Pickup Date, Notes
Continuous Monitoring: Site*, Customer Contact*, Urban Contact, Zoning Noise Target, Monitor Deploy Date, Monitor Pickup Date, Operation* (Drilling, Completion, Production, or Other), Notes,
Noise Impact Assessment: Site*, Customer Contact, Urban Contact, Report Due Date, Operation (Drilling, Completion, Production, or Other), Model NIA based on Compliance, Model NIA based on Set Mitigation, Mitigation Description, Notes,
Equipment Noise Signature: Site*, Customer Contact*, Urban Contact, Report Due Date, Signature Date, Operation* (Drilling, Completion, Production, or Other), Permission to fly Drone, Site Contact Information, Notes
Noise Mitigation Plan: Site*, Customer Contact, Urban Contact, Report Due Date, Operation (Drilling, Completion, Production, or Other), Model NIA based on Compliance, Model NIA based on Set Mitigation, Mitigation Description, Operation Duration and Additional Notes

The NMA server 310 generates a “Site” 105 for each noise study. This links the location of the noise study to the area of impact. This also allows the NMA server 310 to use the mapping and GIS features to show monitor station 330 placement relative to the site 105, areas of impact from the operation, and potential mitigation layers 110 and 115. In some embodiments, the NMA server 310 is able to create the site 105 using a name. The NMA server 310 enters the name into the Sites module. Once a Site 105 is entered and saved, the Noise Module is automatically updated with this Site option. The Site 105 is then linked to the study through the Noise Module by selecting the Site 105 in the general tab. A new Site 105 can also be created using a “Create New Site” button in the study general tab.

When “Customer Contact” is selected from a dropdown list selection, the NMA server 310 is configured to link the customer profile setup. In some embodiments, all dates required may be entered or selected from a calendar popup made available when the date box is selected.

Users can select and document which rules and regulations apply to the Site 105 and Noise study via the NMA server 310. The Municipality information can be tracked in the General Tab allowing users to document which local regulations should be followed. The Mitigation Description text field allows users to document any mitigation efforts to be used or recommend on the Site 105 such as walls, mufflers, or equipment relocation. After filling in the required fields and clicking the “Save and Close” button, the NMA server 310 will start the specific workflow for a Noise study. The workflow represents all the steps and interactions until the study is completed. These workflows highlight what is required of each individual and/or group associated with the noise study.

The NMA server 310 populates emails and/or notifications with each workflow trigger. The NMA server 310 is determines who is the initiator, and who is the recipient of each trigger so that the email/notification goes to the appropriate person(s). The email subject line naming convention is also coded by the NMA server 310 so that the correct customer, site 105, and study type are identified with the appropriate trigger. Specific email verbiage for the needs or updates are generate by the NMA server 310 and included in the email, along with a link that will take the person directly to where they need to be in the NMA system 300 to complete tasks or access information.

Once the NMA server 310 generates a study, or studies, “filter” options on the main study search list can be used to find a study, and track and manage the progress as needed. The NMA server 310 is also configured to generate PDF reports and/or open-source files (GeoJson, KML, etc.) to help with planning and executing operations within noise compliance. In some embodiments, these files may be accessed as a map layer when viewing a map 100.

FIG. 3 depicts a simplified block diagram of an exemplary noise monitoring and analysis (NMA) system 300 in accordance with at least one embodiment. In the exemplary embodiment, system 300 may be used for monitoring and analyzing noise emissions and determining remediation to counteract those emissions. A data storage and access system 300, as described herein, may include a noise monitoring and analysis (NMA) server 310 that is in communication with a plurality of user computer devices 305, one or more third-party servers 325, and one or more monitor stations 330.

As described herein in more detail, the NMA server 310 may be configured to (1) store a plurality of information about a plurality of parameters for one or more noise studies; (2) store one or more models of noise emissions; (3) receive updated information about a first noise study; (4) execute the one or more models of noise emissions with the updated information as inputs to generate an updated model of noise emissions for the first noise study; (5) generate a first map overlay for the first noise study based upon the updated model of noise emissions for the first noise study; and/or (6) transmit instructions to a user computer device 305 to cause a map 100 (shown in FIG. 1) with the first map overlay to be displayed on a display device of the user computer device 305.

In the exemplary embodiment, user computer devices 305 are computers that include a web browser or a software application, which enables user computer devices 305 to access NMA server 310 using the Internet. More specifically, user computer devices 305 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computer devices 305 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, or other web-based connectable equipment or mobile devices.

A database server 315 may be communicatively coupled to a database 320 that stores data. In one embodiment, database 320 may include noise emissions, area profiles, remediation methodologies, and geographic information. In the exemplary embodiment, database 320 may be stored remotely from NMA server 310. In some embodiments, database 320 may be decentralized. In the exemplary embodiment, a person may access database 320 via user computer devices 305 by logging onto NMA server 310, as described herein.

NMA server 310 (also known as NMA computer device 310) may be communicatively coupled with one or more the user computer devices 305. In the exemplary embodiment, NMA server 310 are computers that include a web browser or a software application, which enables NMA server 310 to access user computer devices 305, third-party servers 325, and/or monitor stations 330 using the Internet. More specifically, NMA server 310 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. NMA server 310 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, or other web-based connectable equipment or mobile devices.

Third-party servers 325 may be any third-party server that NMA server 310 is in communication with that provides additional functionality and/or information to NMA server 310. For example, third-party server 325 may provide geographic information, regulatory information, code, knowledge base data, and/or other information.

In the exemplary embodiment, third-party servers 325 are computers that include a web browser or a software application, which enables third-party servers 325 to communicate with NMA server 310 using the Internet, a local area network (LAN), or a wide area network (WAN). In some embodiments, the third-party servers 325 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third-party servers 325 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, monitor stations 330 are computers that include a web browser or a software application, which enables monitor stations 330 to use sensors to monitor noise emission and to communicate with NMA server 310 using the Internet, a local area network (LAN), or a wide area network (WAN). In some embodiments, the monitor stations 330 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Monitor stations 330 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In at least some embodiments, monitor stations 330 includes a plurality of sensors for monitoring vibrations and/or noise emissions.

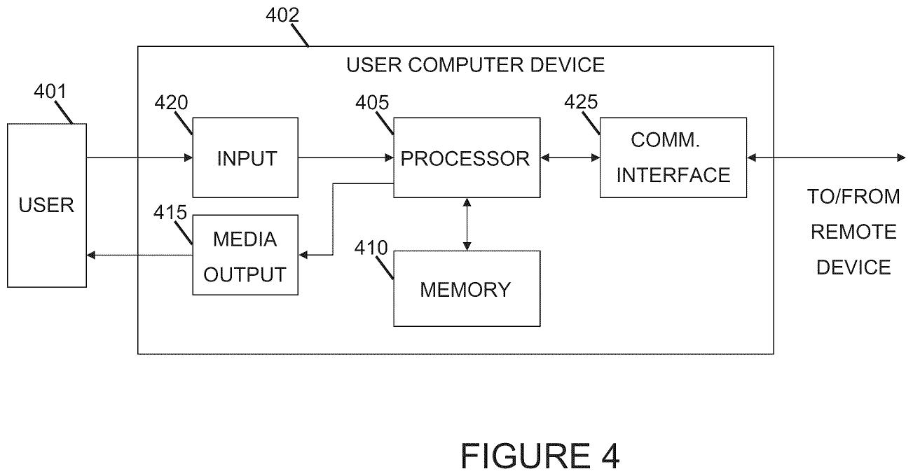

FIG. 4 depicts an exemplary configuration of a user computer device 305 shown in FIG. 3, in accordance with one embodiment of the present disclosure. User computer device 402 may be operated by a user 401. User computer device 402 may include, but is not limited to, user computer devices 305 (shown in FIG. 3). User computer device 402 may include a processor 405 for executing instructions. In some embodiments, executable instructions are stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets).

In some embodiments, media output component 415 may be configured to present a graphical user interface (e.g., a web browser and/or a client application) to user 401. A graphical user interface may include, for example, an online interface for viewing and/or uploading knowledge base data. In some embodiments, user computer device 402 may include an input device 420 for receiving input from user 401. User 401 may use input device 420 to, without limitation, select and/or enter one or more items of knowledge base data to upload and/or view.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as the NMA server 310 (shown in FIG. 3). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from the NMA server 310 and/or the third-party server 325 (shown in FIG. 3). A client application allows user 401 to interact with, for example, the LMA server 310 and/or the third-party server 325. For example, instructions may be stored by a cloud service, and the output of the execution of the instructions sent to the media output component 415.

Processor 405 executes computer-executable instructions for implementing aspects of the disclosure. In some embodiments, the processor 405 is transformed into a special purpose microprocessor by executing computer-executable instructions or by otherwise being programmed.

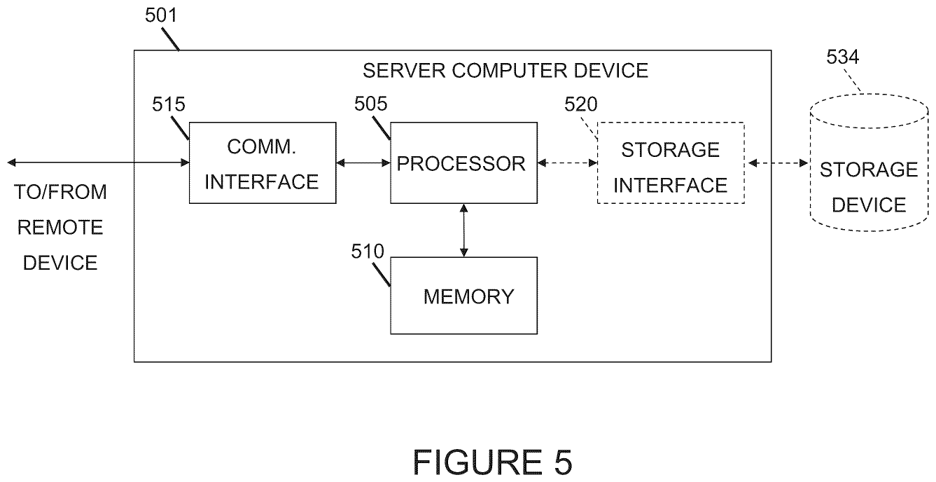

FIG. 5 depicts an exemplary configuration of a server in accordance with one embodiment of the present disclosure. Server computer device 501 may include, but is not limited to, database server 315, NMA server 310, and third-party server 325 (all shown in FIG. 3). Server computer device 501 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, third-party server 325, or user computer devices 305 (shown in FIG. 3). For example, communication interface 515 may receive requests from user computer devices 305 via the Internet, as illustrated in FIG. 3.

Processor 505 may also be operatively coupled to a storage device 534. Storage device 534 may be any computer-operated hardware suitable for storing and/or retrieving data, such as, but not limited to, data associated with database 320 (shown in FIG. 3). In some embodiments, storage device 534 may be integrated in server computer device 501. For example, server computer device 501 may include one or more hard disk drives as storage device 534.

In other embodiments, storage device 534 may be external to server computer device 501 and may be accessed by a plurality of server computer devices 501. For example, storage device 534 may include a storage area network (SAN), a network attached storage (NAS) system, and/or multiple storage units such as hard disks and/or solid-state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instructions such as illustrated in FIG. 2.

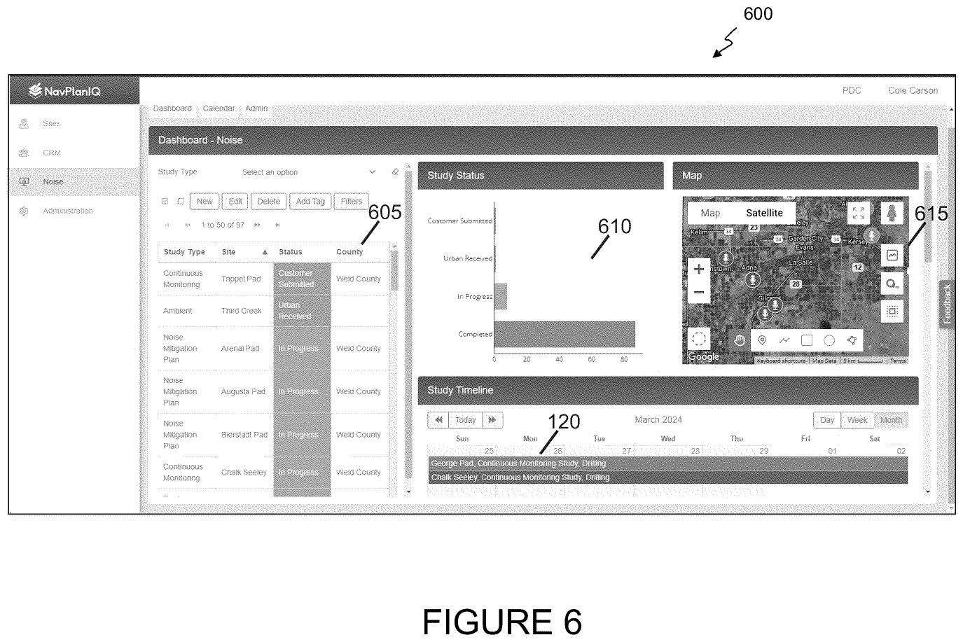

FIG. 6 illustrates an exemplary user interface 600 for use with the NMA system 300 (shown in FIG. 3). In the exemplary embodiment, user interface 600 includes a selection area 605 for selecting a type of study, a status area 610 that displays a current status of various studies, a map 615 of one or more studies, and/or a study timeline 620. The user interface 600 includes a dashboard that is the main screen of interest where all noise studies associated with the customer are listed under a Study Search section. The graphic displays to the right of this list change according to what is listed and filtered on in the Study Search section. These graphics include Study Status (Customer Submitted, In Progress, Urban Received and Completed). There is a display button to filter further and/or export data. Study GIS is the mapping feature that displays where the studies are on a map 615, and provides buttons for a satellite view, to add layers, expand, or circle in on an area. Buttons are available to further filter, adjust the time period of interest, or zoom in or out.

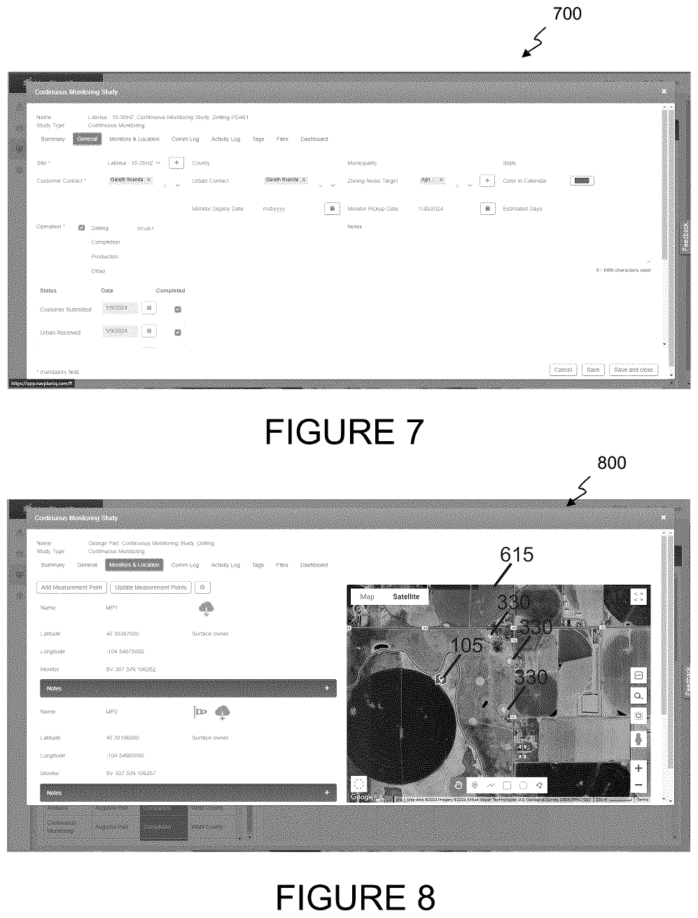

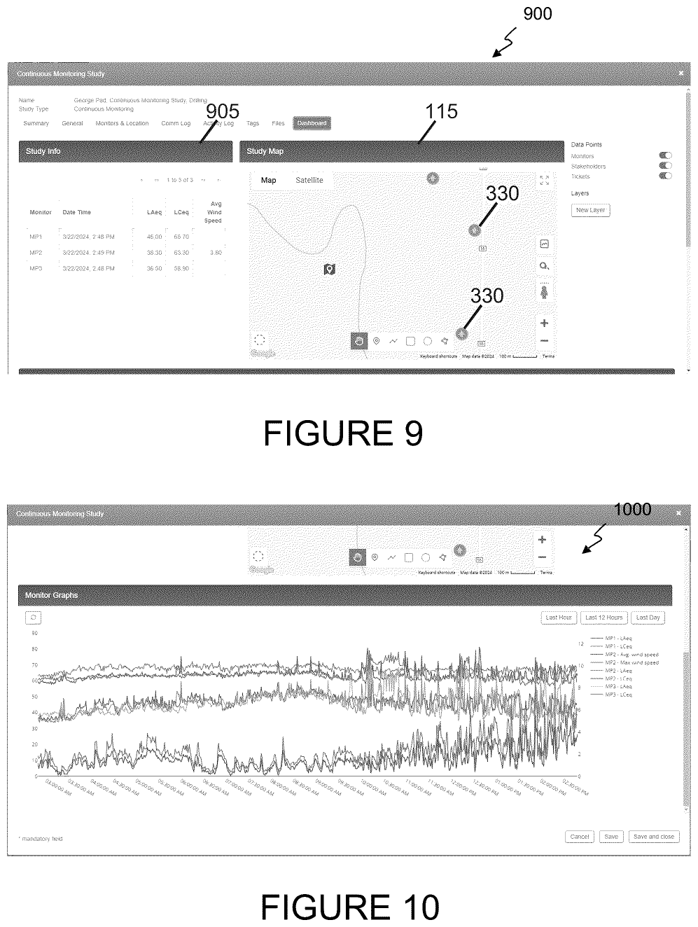

FIG. 7 illustrates an exemplary user interface 700 for setting up a noise study for use with the NMA system 300 (shown in FIG. 3). FIG. 8 illustrates the exemplary user interface 800 being used to set-up monitor stations 330 (shown in FIG. 3) for a noise study. More specifically, the user interface 700 includes the map area 615, that allows a user to place location of the site 105 and the one or more monitoring stations 330 for one or more noise studies. FIG. 9 illustrates an exemplary user interface 900 being used to monitor a noise study. In user interface 900, the map area 615 illustrates the locations of the site 105 and the monitor stations 330. User interface 900 also includes a study information area 905 to provide current information and/or status of the current noise study. FIG. 10 illustrates a graph 1000 of the results of one or more monitor stations 330 (shown in FIG. 3).

In the exemplary embodiment, user interfaces 600, 700, 800, 900, and 1000 are execute by the NMA computer device 310 (shown in FIG. 3). In some embodiments, the NMA computer device 310 causes the user interfaces 600, 700, 800, 900, and 1000 to be displayed on a display device of a user computer device 305 (shown in FIG. 3).

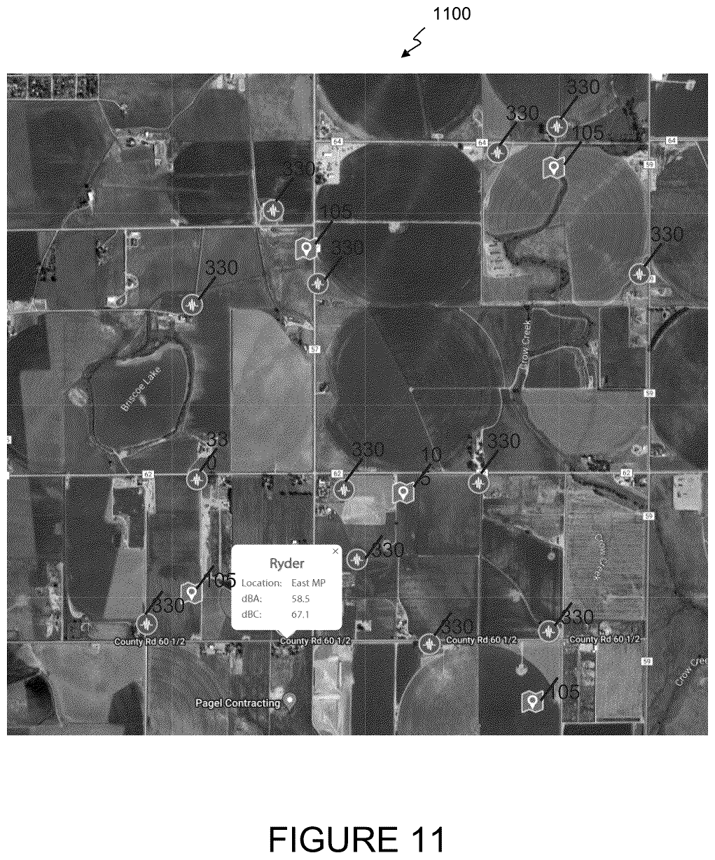

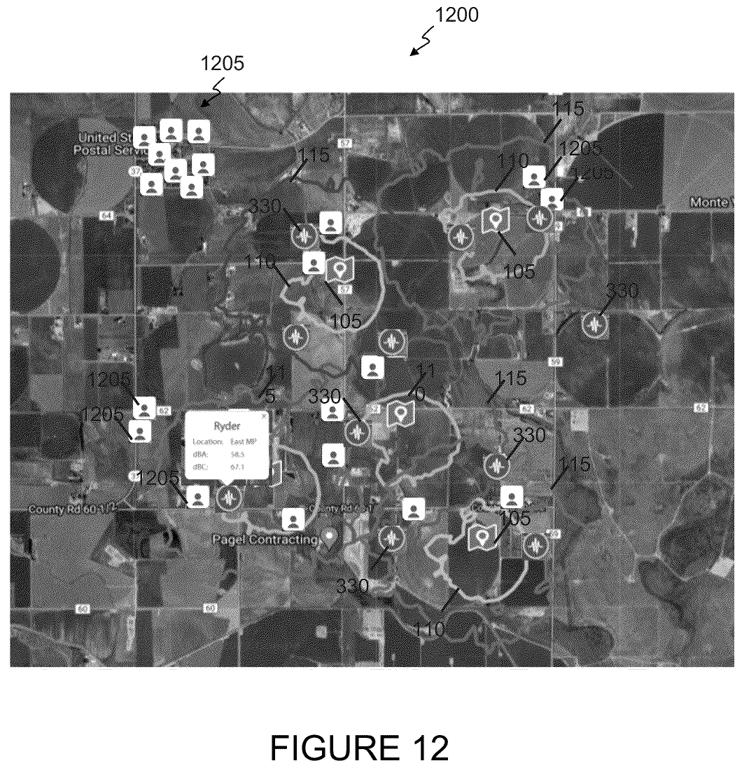

FIG. 11 illustrates a map 1100 of an area with sites 105 and monitor stations 330 for one or more noise studies. FIG. 12 illustrates an updated map 1200 of the map 1100 (shown in FIG. 11) for the one or more noise studies. The updated map 1200 includes the mitigated noise contours 110 and the unmitigated noise contours 115 based on the sites 105. In some embodiments, the NMA system 300 (shown in FIG. 3), allows a user to make changes to the sites 105, the mitigated noise contours 110, and/or the unmitigated noise contours 115. Furthermore, the NMA system 300 may make determinations to adjust the mitigated noise contours 110 and the unmitigated noise contours 115 from information from the monitor stations 330, third-party servers 325, database 320, and/or user computer devices 305 (all shown in FIG. 3). Furthermore, the NMA system 300 may determine information about the site 105 that may automatically adjust the noise contours 110 and 115.

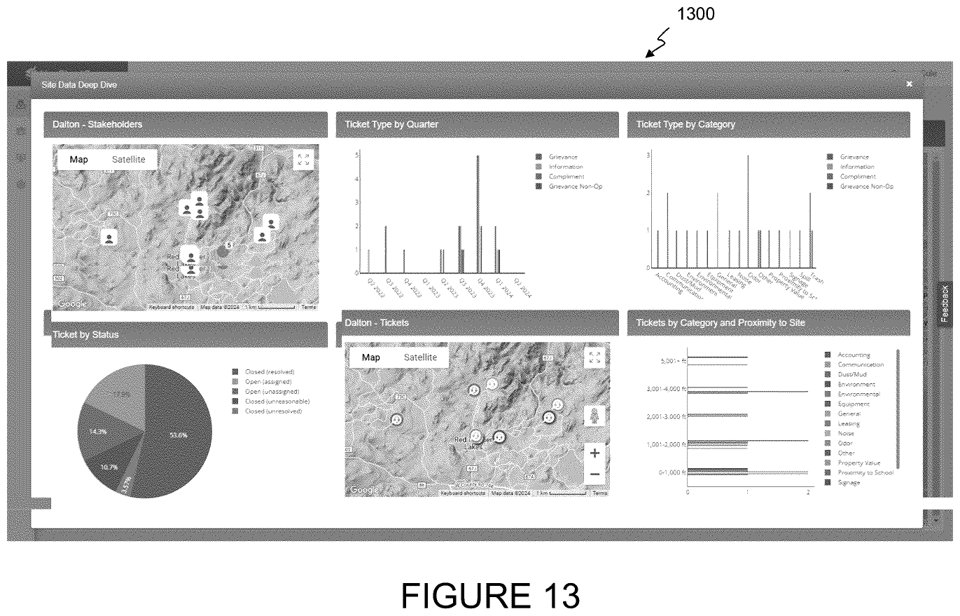

FIG. 13 illustrates a report user interface 1300 that provides information about the noise studies. Report user interface 1300 allows a user to view a plurality of information about one or more noise studies.

As described herein, the NMA system 300 and the NMA computer device 310 support one or more noise modules for monitoring noise studies. The NMA computer device 310 provides a centralized location for historical, current, and future noise study data. The NMA computer device 310 outlines and tracks key points of contact for the users. The NMA computer device 310 allows for uploading, downloading, and storing important noise study information including, but not limited to, grading plans, mitigation descriptions, and reports. The NMA computer device 310 is configured to automatically transmit notifications, such as via email, SMS, MMS, and/or push notifications. These notifications include noise study progress, status updates, and noise monitor station 330 triggers. The NMA computer device 310 documents decisions made and logic for each noise study. The NMA computer device 310 in configured to provide the user with customized reporting and exporting. The NMA computer device 310 provides GIS spatial mapping features that tie the noise study data to specific locations and/or projects. Furthermore, the NMA computer device 310 is able to convert all noise data into open-source files for planning and layout tools in a GIS layer.

The NMA system 300 and the NMA computer device 310 provides noise impact assessments and/or noise mitigation plans. The NMA computer device 310 includes the ability to outline if the study needs to be modeled for compliance or pre-determined mitigation to accommodate other mitigation requirements, including those outside of noise. The NMA computer device 310 tracks studies for the entire development lifecycle, such as from planning and/or permitting through the execution and reclamation. The NMA computer device 310 then converts noise data into open-source files for use as one or more interactive map layers.

The NMA system 300 and the NMA computer device 310 support the ambient studies. The NMA computer device 310 tracks the progress of the noise studies from submittal to monitor deployment to data gathering to monitor retrieval. The NMA computer device 310 import results to the noise layers for ease of compliance checks. The NMA computer device 310 also provides information from the plurality of monitor stations 330.

The NMA system 300 and the NMA computer device 310 also supports the continuous monitoring of the plurality of monitor stations 330. The NMA computer device 310 provides documented compliance points from historical ambient data to streamline services. The NMA computer device 310 uses the continuous monitoring to align with regulatory requirements. The NMA computer device 310 tracks progress of noise studies from submittal to monitor deployment to data gathering to monitor retrieval. The NMA computer device 310 provides historical ambient report data that may be used as one or more layers.

### Additional Considerations

In the preceding specification and the following claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The computer-implemented methods discussed herein may include additional, fewer, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

The aspects described herein may be implemented as part of one or more computer components such as a client device and/or one or more back-end components, such as a cloud service server, for example. Furthermore, the aspects described herein may be implemented as part of computer network architecture and/or a cognitive computing architecture that facilitates communications between various other devices and/or components. Thus, the aspects described herein address and solve issues of a technical nature that are necessarily rooted in computer technology.

Furthermore, the embodiments described herein improve upon existing technologies, and improve the functionality of computers, by improving the security of provisioning devices and preventing their access to the network before they are fully provisioned. The present embodiments improve the speed, efficiency, and accuracy in which such calculations and processor analysis may be performed. Due to these improvements, the aspects address computer-related issues regarding efficiency over conventional techniques. Thus, the aspects also address computer related issues that are related to computer security, for example.

Accordingly, the innovative systems and methods described herein are of particular value within the realm of secure Internet communications. The present embodiments enable more reliable security during the device provisioning process, but without compromising data and speed. Furthermore, according to the disclosed techniques, user computer devices are better able to ensure the security of websites and other connected devices, and thereby protecting computer devices from malicious actors.

Exemplary embodiments of systems and methods for provisioning devices are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for dynamic noise compliance comprising a computer device comprising at least one processor in communication with at least one memory device, wherein the at least one processor is programmed to:
store a plurality of information about a plurality of parameters for one or more noise studies;
store one or more models of noise emissions;
receive updated information about a first noise study;
execute the one or more models of noise emissions with the updated information as inputs to generate an updated model of noise emissions for the first noise study;
generate a first map overlay for the first noise study based upon the updated model of noise emissions for the first noise study; and
transmit instructions to a user computer device to cause a map with the first map overlay to be displayed on a display device of the user computer device.

2. The system in accordance with claim 1, wherein the at least one processor is further programmed to generate the first map overlay to include a first area indicating noise contours of mitigated compliance.

3. The system in accordance with claim 2, wherein the at least one processor is further programmed to generate the first map overlay to include a second area indicating noise contours of unmitigated compliance.

4. The system in accordance with claim 1, wherein the at least one processor if further programmed to transmit a notification about a current stage of the first noise study to a user computer device.

5. The system in accordance with claim 1, wherein the at least one processor is further programmed to be in communication with one or more monitor stations, and wherein the at least one processor is further programmed to receive current noise emissions from the one or more monitor stations.

6. The system in accordance with claim 5, wherein the at least one processor is further programmed to execute the updated model of the first noise study with the current noise emissions as inputs to generate the current updated model of noise emissions for the first noise study.

7. The system in accordance with claim 6, wherein the at least one processor is further programmed to update the first map overlay for the first noise study based upon the current model of noise emissions for the first noise study.

8. The system in accordance with claim 1, wherein the at least one processor is further programmed to:
store the plurality of information about the plurality of parameters for a plurality of noise studies including the first noise study; and
display information about one or more of the plurality of noise studies.

9. The system in accordance with claim 1, wherein the plurality of parameters includes a plurality of compliance regulations for noise emissions and wherein the updated model of the first noise study determines whether or not one or more sites associated with the first noise study are in compliance with the plurality of compliance regulations.

10. A computer implemented method for dynamic noise compliance implemented by a computer device comprising at least one processor in communication with at least one memory device, wherein the method comprises:
storing a plurality of information about a plurality of parameters for one or more noise studies;
storing one or more models of noise emissions;
receiving updated information about a first noise study;
executing the one or more models of noise emissions with the updated information as inputs to generate an updated model of noise emissions for the first noise study;
generating a first map overlay for the first noise study based upon the updated model of noise emissions for the first noise study; and
transmitting instructions to a user computer device to cause a map with the first map overlay to be displayed on a display device of the user computer device.

11. The computer implemented method in accordance with claim 10 further comprising generating the first map overlay to include a first area indicating noise contours of mitigated compliance.

12. The computer implemented method in accordance with claim 11 further comprising generating the first map overlay to include a second area indicating noise contours of unmitigated compliance.

13. The computer implemented method in accordance with claim 10 further comprising transmitting a notification about a current stage of the first noise study to a user computer device.

14. The computer implemented method in accordance with claim 10, wherein the at least one processor is further programmed to be in communication with one or more monitor stations, and wherein the method further comprises receiving current noise emissions from the one or more monitor stations.

15. The computer implemented method in accordance with claim 14 further comprising executing the updated model of the first noise study with the current noise emissions as inputs to generate the current updated model of noise emissions for the first noise study.

16. The computer implemented method in accordance with claim 15 further comprising updating the first map overlay for the first noise study based upon the current model of noise emissions for the first noise study.

17. The computer implemented method in accordance with claim 10 further comprising:
storing the plurality of information about the plurality of parameters for a plurality of noise studies including the first noise study; and
displaying information about one or more of the plurality of noise studies.

18. The computer implemented method in accordance with claim 10, wherein the plurality of parameters includes a plurality of compliance regulations for noise emissions and wherein the updated model of the first noise study determines whether or not one or more sites associated with the first noise study are in compliance with the plurality of compliance regulations.

19. At least one non-transitory computer-readable storage media having computer-executable instructions embodied thereon, wherein when executed by at least one processor of a computer system, the computer-executable instructions cause the processor to:
store a plurality of information about a plurality of parameters for one or more noise studies;
store one or more models of noise emissions;
receive updated information about a first noise study;
execute the one or more models of noise emissions with the updated information as inputs to generate an updated model of noise emissions for the first noise study;
generate a first map overlay for the first noise study based upon the updated model of noise emissions for the first noise study; and
transmit instructions to a user computer device to cause a map with the first map overlay to be displayed on a display device of the user computer device.

20. The non-transitory computer-readable storage media in accordance with claim 19, the computer-executable instructions further cause the processor to:
generate the first map overlay to include a first area indicating noise contours of mitigated compliance; and
generate the first map overlay to include a second area indicating noise contours of unmitigated compliance.
